(19) United States
(12) Patent Application Publication
(10) Pub. No.: US 2014/0199943 A1
(43) Pub. Date: Jul. 17, 2014

(54) METHOD AND APPARATUS FOR TRANSFERRING CONTENT BETWEEN PORTABLE ELECTRONIC DEVICES

(71) Applicant: SAMSUNG ELECTRONICS CO., LTD., Suwon-si (KR)

(72) Inventors: Revoti Prasad BORA, Noida (IN); Apangshu SAHA, Noida (IN); Harshit MATHUR, Noida (IN)

(73) Assignee: SAMSUNG ELECTRONICS CO., LTD., Suwon-si (KR)

(21) Appl. No.: 14/155,828

(22) Filed: Jan. 15, 2014

(30) Foreign Application Priority Data
Jan. 15, 2013 (IN) 191/CHE/2013
Oct. 31, 2013 (KR) 10-2013-0131510

(51) Int. Cl. H04W 4/00

(52) U.S. Cl. CPC H04W 4/008
USPC 455/41.1

(57) ABSTRACT

A method and device for transferring content between electronic devices are provided. The method of transferring a content file in a communication device includes receiving information related to the content file from a portable electronic device through near field communication, receiving the content file from the portable electronic device through a second communication channel, and transferring the received information related to the content file and the content file to another communication device through a first communication channel.

### RELATED APPLICATIONS

This application claims priority from Indian Patent Application No. 191/CHE/2013, filed on Jan. 15, 2013 in the Indian Patent Office and Korean Patent Application No. 10-2013-0131510, filed on Oct. 31, 2013 in the Korean Intellectual Property Office, the disclosures of which are incorporated by reference herein in their entireties.

### BACKGROUND

1. Field

Apparatuses and methods consistent with exemplary embodiments relate to electronic devices, and more particularly, to transferring content between portable electronic devices.

2. Description of the Related Art

File transfer applications depend on manual configurations by users these days. A connection setting initiation process is started only after receiving a request from a user. Content including files is shared over communication channels in related art systems. However, content needs to exist in a local side in order to be transferred to a remote side, and there is no way to transfer content to an external device. Accordingly, a user is required to copy content from an external device, but copying is a tedious and time-consuming process. Thus, such systems overlook the existence of the external device.

In this regard, there is a need to develop an efficient method and a system for seamlessly transferring content between electronic devices.

### SUMMARY

One or more exemplary embodiments provide a method and apparatus for transferring content between electronic devices.

According to an aspect of an exemplary embodiment, there is provided a method of transferring a content file in a communication device, the method including receiving information related to the content file from a portable electronic device through near field communication, receiving the content file from the portable electronic device through a second communication channel, and transferring the received information related to the content file and the content file to another communication device through a first communication channel.

According to an aspect of another exemplary embodiment, there is provided a method of transferring a content file in a communication device, the method including receiving the content file and information related to the content file from another communication device through a first communication channel, receiving a near field communication request from a portable electronic device, transferring the information related to the content file to the portable electronic device in response to the near field communication request, and transferring the content file to the portable electronic device through a second communication channel.

According to an aspect of another exemplary embodiment, there is provided a communication device that transfers a content file, the communication device including a near field communication transmitter and receiver configured to receive information related to the content file from a portable electronic device through near field communication, and a file transmitter and receiver configured to receive the content file from the portable electronic device through a second communication channel and to transfer the information related to the received content file and the content file to another communication device through a first communication channel.

According to an aspect of another exemplary embodiment, there is provided a communication device that transfers a content file, the communication device including a file transmitter and receiver that is configured to receive the content file and information related to the content file from another communication device through a first communication channel, and a near field communication transmitter/receiver that is configured to receive a near field communication request from a portable electronic device and transfer the information related to the content file to the portable electronic device in response to the near field communication request, wherein the file transmitter and receiver transfers the content file to the portable electronic device through a second communication channel.

### BRIEF DESCRIPTION OF THE DRAWINGS

The and/or other aspects will become apparent and more readily appreciated from the following description of exemplary embodiments, taken in conjunction with the accompanying drawings in which:

FIG. 1 is a block diagram of an environment for transferring content between portable electronic devices, according to an exemplary embodiment;

FIG. 2 is a block diagram of a portable electronic device according to an exemplary embodiment;

FIG. 3 is a block diagram of a main communication device according to an exemplary embodiment;

FIG. 4 is a flowchart of a method of transferring content received from a portable electronic device to a communication device, according to an exemplary embodiment; and

FIG. 5 is a flowchart of a method of transferring content received from a communication device to a portable electronic device, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description.

In the present specification, the terms indicating a relationship such as “first” and “second” may be used to distinguish one entity from another entity rather than unnecessarily implying an actual relationship or order between entities. Expressions such as “at least one of,” when preceding a list of elements, modify the entire list of elements and do not modify the individual elements of the list.

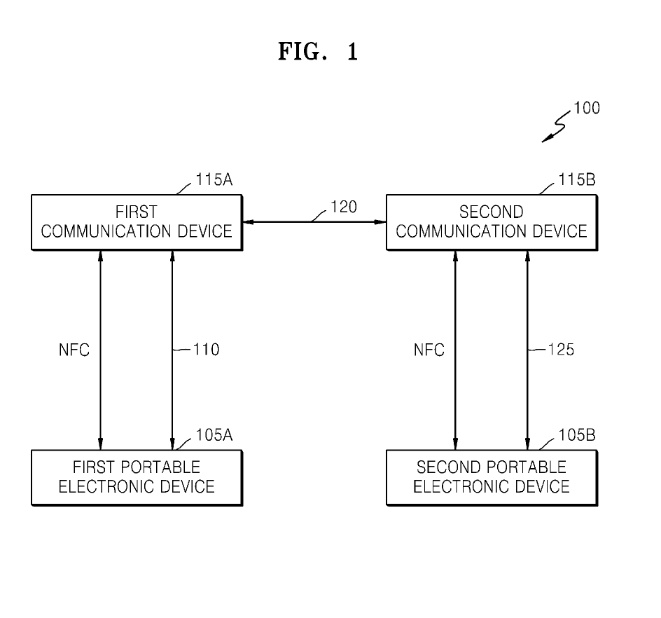

FIG. 1 is a block diagram of an environment 100 for transferring content between portable electronic devices, according to an exemplary embodiment. The environment 100 includes a plurality of portable electronic devices, for example, a first portable electronic device 105A and a second portable electronic device 105B, a plurality of communication devices, for example, a first communication device 115A and a second communication device 115B, a first communication channel 120, a second communication channel 110, and a third communication channel 125. The first portable electronic device 105A of a first user is connected to the first communication device 115A through the second communication channel 110. The first communication device 115A is connected to the second communication device 115B through the first communication channel 120. The second portable electronic device 105B of a second user is connected to the second communication device 115B through the third communication channel 125.

Examples of a portable electronic device include mobile devices, tablets, personal digital assistances (PDAs), and smartphones, without being limited thereto. Examples of a communication device include computers and laptops, without being limited thereto. Examples of the first communication channel 120 include audio, video, or a text chat session via a network such as a local area network (LAN), a wide area network (WAN), or a wireless network, without being limited thereto. Examples of the second communication channel 110 and the third communication channel 125 include Bluetooth and Wi-Fi, without being limited thereto.

In the environment 100, the first portable electronic device 105A transfers a first plurality of parameters related to a file stored in the first portable electronic device 105A to the first communication device 115A through near field communication (NFC), and a content file is copied to the first communication device 115A by using the second communication channel 110 based on the first plurality of parameters. Then, the content file is copied from the first communication device 115A to the second communication device 115B by using the first communication channel 120. In this regard, the second communication device 115B, which is a target communication device to which the content file received from the first portable electronic device 105A is transferred, is pre-set in the first communication device 115A. Thus, when the content file is received from the first portable electronic device 105A, the first communication device 115A automatically transfers the content file to the second communication device 115B. The second portable electronic device 105B receives the first plurality of parameters related to the content file from the second communication device 115B through NFC to trigger a content file transfer operation, and then receives the content file from the second communication device 115B through the third communication channel 125.

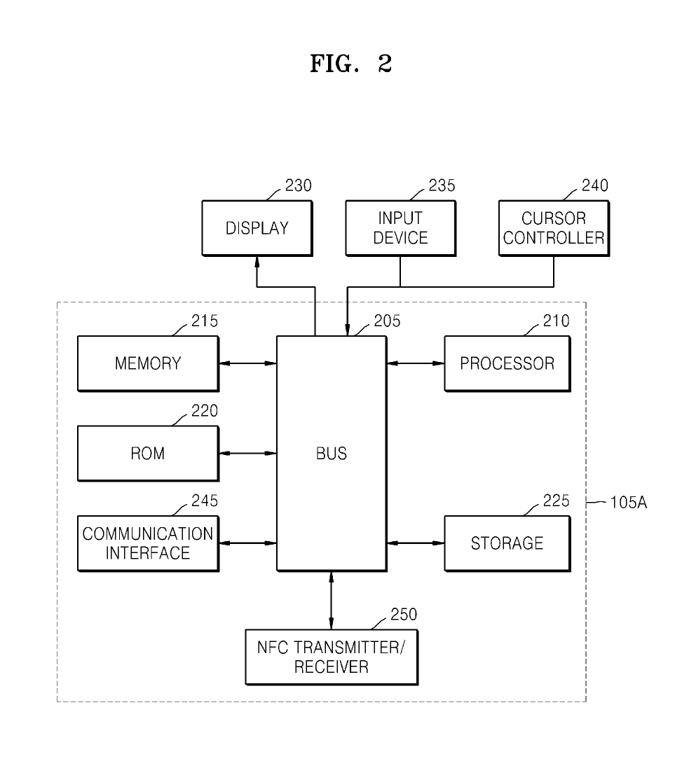

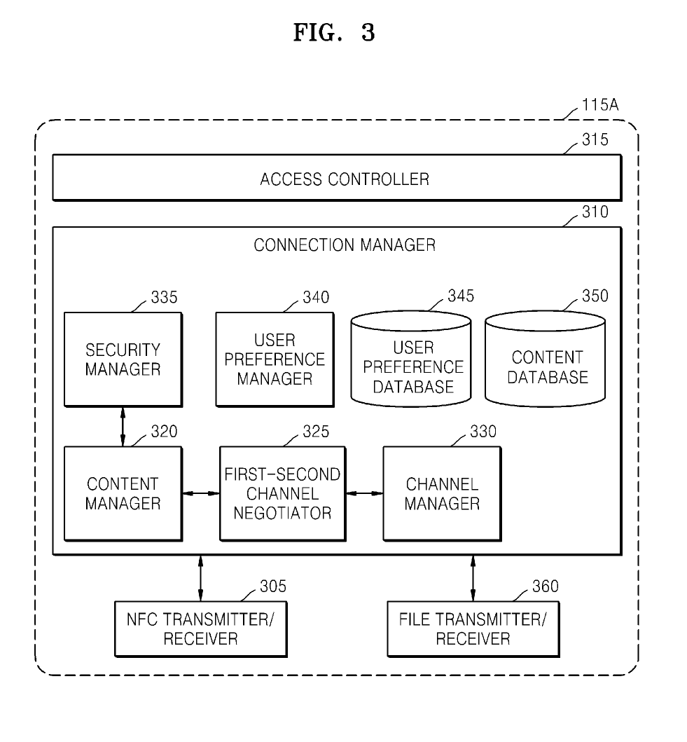

A portable electronic device, for example, the first portable electronic device 105A, including a plurality of components, will be described in detail with reference to FIG. 2. A communication device, for example, the first communication device 115A, including a plurality of components, will be described in detail with reference to FIG. 3.

FIG. 2 is a block diagram of a portable electronic device according to an exemplary embodiment, e.g., the first portable electronic device 105A.

The first portable electronic device 105A includes a bus 205 or other communication system for information communication, and a processor 210 connected to the bus 205 and used for processing information. The first portable electronic device 105A further includes a memory 215, such as random-access memory (RAM) or other dynamic storage devices, coupled to the bus 205. The memory 215 stores information and instructions to be executed by the processor 210. The memory 215 may be used to store temporary variables or other intermediate information while the processor 210 executes instructions. The first portable electronic device 105A further includes read-only memory (ROM) 220 or other static storage devices which are connected to the bus 205 and store static information and instructions for execution by the processor 210. A storage 225, such as a magnetic disk or an optical disc, is provided and connected to the bus 205.

The first portable electronic device 105A may be coupled to a display 230 such as a cathode ray tube (CRT) display or an LCD display or other display through the bus 205 in order to display content. An input device 235, including alphanumeric keys and other keys, is connected to the bus 205 in order to transfer information and commands to the processor 210. Another type of user input device is a cursor controller 240, such as a mouse, a trackball, or a cursor direction key, to transfer directional information and a selected command to the processor 210 and to control movement of a cursor on the display 230.

Various exemplary embodiments are related to the use of the first portable electronic device 105A to implement techniques described herein. In some exemplary embodiments, the first portable electronic device 105A performs techniques described herein in response to the processor 210 that executes instructions stored in the memory 215. Such instructions may be read by other machine-readable media, e.g., the storage 225, into the memory 215. The processor 210 performs a process described herein by executing the instruction stored in the memory 215.

In some exemplary embodiments, the processor 210 may include at least one central processing unit (CPU) that performs at least one function of the processor 210. The CPU is a hardware circuit used in place of or in combination with software instructions to perform a predetermined function.

The term “machine-readable medium” as used herein refers to a medium that participates in providing data to allow a machine to perform a predetermined function. In an exemplary embodiment implemented using the first portable electronic device 105A, a variety of machine-readable media may be involved, for example, in providing instructions to the processor 210 for execution thereof. The machine-readable medium may be a volatile or nonvolatile storage medium. For example, the volatile medium includes a dynamic memory such as the memory 215. For example, the nonvolatile medium includes an optical or magnetic disk such as the storage 225. All such media may be tangible such that a physical mechanism, which reads the instructions into a machine, detects the instructions carried by the media.

Examples of the machine-readable medium may include a floppy disk, a flexible disk, a hard disk, magnetic tape, or any other magnetic media, a CD-ROM, any other optical media, punchcards, papertape, any other physical media with patterns of holes, RAM, programmable read-only memory (PROM), erasable programmable read-only memory (EPROM), FLASH-EPROM, and any other memory chip or cartridge.

The storage 225 stores the content file to be transferred to the first communication device 115A and information related to the content file, i.e., a plurality of parameters related to the content file.

According to another exemplary embodiment, the machine-readable medium may be a transmission medium including coaxial cables, copper wires, and optical fibers or a transmission medium including wires that include the bus 205. The transmission medium may have the form of acoustic or light waves, such as waves generated during radio-wave and infrared-data communication. Examples of the machine-readable medium include any other media readable by a portable electronic device, without being limited thereto. For example, the instructions may be initially stored on a magnetic disk of a remote computer. The remote computer may load the instructions into a dynamic memory thereof and send the instructions over a telephone line by using a modem. A modem local to the first portable electronic device 105A may receive data via the telephone line and use an infrared transmitter to convert the data into an infrared signal. An infrared detector may receive the data carried in the infrared signal and an appropriate circuit may transfer the data to the bus 205. The bus 205 transfers the data to the memory 215, from which the processor 210 retrieves and executes the instructions. The instructions received by the memory 215 may optionally be stored in the storage 225 before or after execution by the processor 210. All such media should be tangible such that a physical mechanism, which reads the instructions into a machine, detects the instructions carried by the media.

The first portable electronic device 105A may further include a communication interface 245 connected to the bus 205. The communication interface 245 provides two-way data communication connecting the first portable electronic device 105A with the first communication device 115A. Similarly, the second portable electronic device 105B includes a communication interface 245 connecting the portable electronic device 105B with the second communication device 115B. For example, the communication interface 245 may be an integrated services digital network (ISDN) card or a modem to provide a data communication connection to a corresponding type of telephone line. As another example, the communication interface 245 may be a LAN card to provide a data communication connection to a compatible LAN. In such exemplary embodiments, the communication interface 245 transmits and receives electrical signals, electromagnetic signals, or optical signals which carry digital data streams representing various types of information.

In addition, the first portable electronic device 105A may include an NFC transmitter and receiver (transmitter/receiver) 250 connected to the bus 205. The NFC transmitter/receiver 250 constitutes an NFC interface for the first portable electronic device 105A to communicate with devices using NFC technology and protocols, such as the first communication device 115A, wirelessly. When the first user brings the first portable electronic device 105A toward the first communication device 115A in order to initiate transfer of the content file, the NFC transmitter/receiver 250 automatically transfers the plurality of parameters related to the content file to the first communication device 115A, and then automatically transfers the content file to the first communication device 115A through the second communication channel 110.

The configuration of the first portable electronic device 105A as illustrated in FIG. 2 may also be applied to that of the second portable electronic device 105B illustrated in FIG. 1. In his case, however, when a second user brings the second portable electronic device 105B toward the second communication device 115B in order to receive the content file, the NFC transmitter/receiver 250 automatically receives a plurality of parameters related to the content file from the second communication device 115B, and then automatically receives the content file from the second communication device 115B through the third communication channel 125.

FIG. 3 is a block diagram of a communication device according to an exemplary embodiment, for example, the first communication device 115A. The first communication device 115A includes an NFC transmitter/receiver 305, a connection manager 310, and an access controller 315. The connection manager 310 includes a content manager 320, a first-second channel negotiator 325, a channel manager 330, a security manager 335, a user preference manager 340, a user preference database 345, and a content database 350. The first communication device 115A and the second communication device 115B may mostly have the same elements, but the elements may operate differently. Hereinafter, only operations of the second communication device 115B that are different from operation of the first communication device 115A will be described.

The NFC transmitter/receiver 305 may transmit or receive configuration files to/from an NFC-enabled device, for example, a portable electronic device. Since the NFC transmitter/receiver 305 has a low data transmission rate, the NFC transmitter/receiver 305 of the first communication device 115A is used to receive initial setting parameters of the content file such as file name and location parameters.

The configuration of the first communication device 115A illustrated in FIG. 3 may also be applied to that of the second communication device 115B illustrated in FIG. 1. In this case, however, when a NFC request is received as the second user brings the second portable electronic device 105B toward the second communication device 115B or taps the second communication device 115B with the second portable electronic device 105B in order to receive the content file, the NFC transmitter/receiver 305 of the second communication device 115B transfers a plurality of parameters related to the content file to the second portable electronic device 105B.

The connection manager 310 adjusts connection related functions among the security manager 335, the content manager 320, the user preference manager 340, the first-second channel negotiator 325, and the channel manager 330. The connection manager 310 may also operate as an interface for the access controller 315. The access controller 315 processes privilege rights to use the connection manager 310.

The content manager 320 is responsible for managing content, e.g., the aforementioned file, and initiating transfer of the content. The content of the file received from the first portable electronic device 105A is also stored in the content database 350. In addition, the target communication device, i.e., the second communication device 115B, to which the content file received from the first portable electronic device 105A is transferred, may be pre-set. That is, the user may pre-set the target communication device, to which the content file received from the first portable electronic device 105A is transferred, in the first communication device 115A, and then the content manager 320 may manage the content file to be automatically transferred to the pre-set target communication device. Alternatively, information related to the content file received from the first portable electronic device 105A may include information related to the target communication device, i.e., the second communication device 115B. In this case, the content manager 320 may obtain the information related to the target communication device by parsing the information related to the content file.

The first-second channel negotiator 325 is responsible for negotiation of the content transfer from the second communication channel 110 to the first communication channel 120, or in the case of the second communication device 115B from the first communication channel 120 to the third communication channel 125.

The channel manager 330 is responsible for maintaining a list of the channels and properties of the list of channels.

The security manager 335 is responsible for embodying security features, e.g. encryption, and policy based request screening.

The user preference manager 340 is responsible for monitoring logging of user preferences. The user preferences are stored in the user preference database 345.

A file transmitter/receiver receives the content file from a portable electronic device and stores the received content file in the content database 350. In addition, the file transmitter/receiver 360 transfers the content file and the information related to the content file, which are stored in the content database 350, to the second communication device 115B.

When the configuration of the first communication device 115A as illustrated in FIG. 3 is applied to the second communication device 115B illustrated in FIG. 1 in the same manner, the file transmitter/receiver 360 serves to transfer the content file stored in the content database 350 to the second portable electronic device 105B.

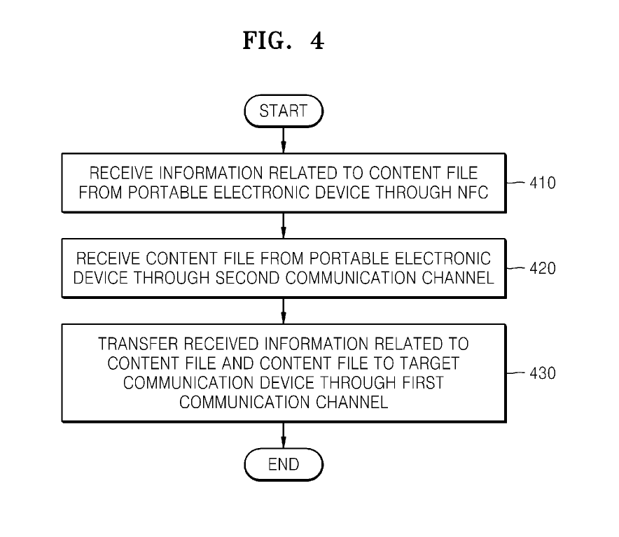

FIG. 4 is a flowchart of a method of transferring content received from the first portable electronic device 105A to the second communication device 115B in the first communication device 115A, according to an exemplary embodiment.

In operation 410, the first communication device 115A receives information related to a content file stored in the first portable electronic device 105A, e.g., an electronic display device, of the first user through NFC. The content file-related information includes a first plurality of parameters related to the content file. Examples of the first plurality of parameters include identification and setting parameters, without being limited thereto. The file may include a configuration file. In some exemplary embodiments, the first user may physically tap the first communication device 115A with the first portable electronic device 105A to trigger the file transfer operation.

In some exemplary embodiments, the first plurality of parameters may include information related to a target communication device to which the content file is transferred.

In operation 420, a communication device, e.g., the first communication device 115A, receives the content file from the first portable electronic device 105A through a communication channel, e.g., the second communication channel 110, based on the first plurality of parameters.

In operation 430, the first communication device 115A transfers the content file and the content file-related information to another communication device, e.g., the second communication device 115B, through another communication channel, e.g., the first communication channel 120. In this regard, the second communication device 115B, as the target communication device to which the content file is transferred, may be pre-set in the first communication device 115A by the user or may be contained in the content file-related information received from the first portable electronic device 105A.

In some exemplary embodiments, the first communication channel 120 may be identified from at least one reference channel.

In some exemplary embodiments, authorization by the first user is determined before the file transfer.

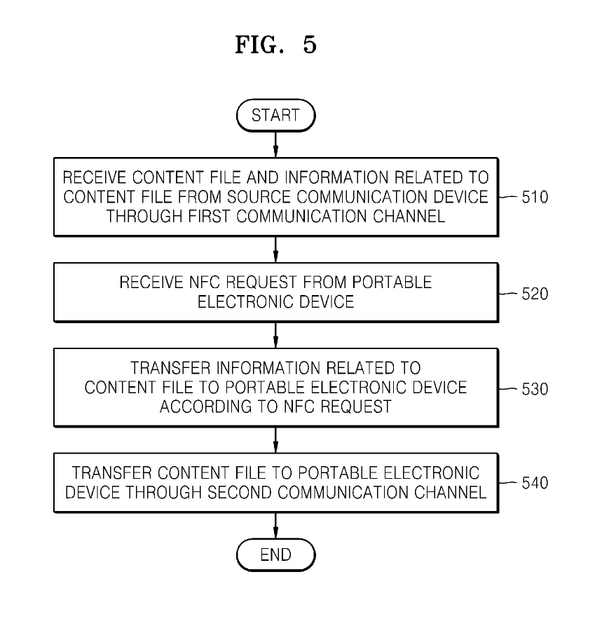

FIG. 5 is a flowchart of a method of transferring content received from a communication device to a portable electronic device, according to an exemplary embodiment.

In operation 510, the second communication device 115B receives the content file and information related to the content file from a source communication device, i.e., the first communication device 115A through the first communication channel 120.

In operation 520, when the second user wishes to download the content file to the second portable electronic device 105B, the second user brings the second portable electronic device 105B into near field communication with the second communication device 115B. The second user may physically tap the second communication device 115B with the second portable electronic device 105B. Accordingly, the second communication device 115B receives a NFC request from the second portable electronic device 105B.

In operation 530, the second communication device 115B transfers the content file-related information, i.e., a second plurality of parameters related to the content file, to the second portable electronic device 105B through NFC in response to the NFC request received from the second portable electronic device 105B. Examples of the second plurality of parameters include a file name, location parameters, and file parameters, without being limited thereto.

In operation 540, the second communication device 115B transfers the content file to the second portable electronic device 105B via the third communication channel 125.

In some exemplary embodiments, at least one file may be transferred.

In some exemplary embodiments, authorization by the second user is determined before the file transfer.

According to exemplary embodiments, a seamless transfer of content may be carried out between electronic devices. Users may efficiently share content via a plurality of external devices. According to exemplary embodiments, a user-friendly method of sharing files is provided. Users may make full use of the existing communication channels according to exemplary embodiments.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present inventive concept as defined by the following claims.

What is claimed is:

1. A method of transferring a content file in a communication device, the method comprising:
receiving information related to the content file from a portable electronic device through near field communication;
receiving the content file from the portable electronic device through a second communication channel; and
transferring the received information related to the content file and the received content file to another communication device through a first communication channel.

2. The method of claim 1, wherein the receiving the information related to the content file through near field communication comprises recognizing a tap operation with the portable electronic device.

3. The method of claim 1, further comprising:
receiving information related to the other communication device to which the content file received through near field communication is to be transferred; and
setting a destination for transfer of the content file to the other communication device by using the information related to the other communication device.

4. The method of claim 1, wherein the information related to the content file comprises information related to the other communication device to which the content file is to be transferred.

5. A method of transferring a content file in a communication device, the method comprising:
receiving the content file and information related to the content file from another communication device through a first communication channel;
receiving a near field communication request from a portable electronic device;
transferring the information related to the content file to the portable electronic device in response to the near field communication request; and
transferring the content file to the portable electronic device through a second communication channel.

6. The method of claim 5, wherein the receiving of the near field communication request comprises recognizing a tap operation with the portable electronic device.

7. A communication device comprising:
a near field communication transmitter and receiver configured to receive information related to a content file from a portable electronic device through near field communication; and
a file transmitter and receiver configured to receive the content file from the portable electronic device through a second communication channel and to transfer the information related to the received content file and the content file to a another communication device through a first communication channel.

8. The communication device of claim 7, wherein the near field communication transmitter and receiver is configured to recognize a tap operation with the portable electronic device.

9. The communication device of claim 7, further comprising a content manager configured to receive information related to the other communication device to which the content file received through near field communication is to be transferred and to set a destination for transfer of the content file to the other communication device by using the information related to the other communication device.

10. The communication device of claim 7, wherein the information related to the content file comprises information related to the other communication device to which the content file is to be transferred.

11. A communication device comprising:
a file transmitter and receiver configured to receive a content file and information related to the content file from another communication device through a first communication channel; and
a near field communication transmitter and receiver configured to receive a near field communication request from a portable electronic device and transfer the information related to the content file to the portable electronic device in response to the near field communication request,
wherein the file transmitter and receiver is configured to transfer the content file to the portable electronic device through a second communication channel.

12. The second communication device of claim 11, wherein the near field communication transmitter and receiver is configured to recognize a tap operation with the portable electronic device.

13. A computer-readable recording medium comprising a program that is executable by a computer to perform a method of transferring a content file in a communication device, the program comprising:
receiving information related to the content file from a portable electronic device through near field communication;
receiving the content file from the portable electronic device through a second communication channel; and
transferring the received information related to the received content file and the content file to another communication device through a first communication channel.

14. The method of claim 1, wherein the second communication channel does not use near field communication.

15. The method of claim 5, wherein the second communication channel does not use near field communication.

16. The first communication device of claim 7, wherein the second communication channel does not use near field communication.

17. The second communication device of claim 11, wherein the second communication channel does not use near field communication.

18. The computer-readable recording medium of claim 13, wherein the second communication channel does not use near field communication.
